(19) United States
(12) Patent Application Publication
(10) Pub. No.: US 2014/0032284 A1
(43) Pub. Date: Jan. 30, 2014

(54) SYSTEM AND METHOD FOR VALIDATING THE COMPLETION OF AN INTERACTIVE MARKETING TASK USING A MOBILE DEVICE

(71) Applicant: Jeffrey Kohn, Englewood, CO (US)

(72) Inventor: Jeffrey Kohn, Englewood, CO (US)

(73) Assignee: TOPFAN, INC., Englewood, CO (US)

(21) Appl. No.: 13/952,572

(22) Filed: Jul. 26, 2013

Related U.S. Application Data
(60) Provisional application No. 61/676,296, filed on Jul. 26, 2012.

(51) Int. Cl. G06Q 30/02

(52) U.S. Cl. CPC G06Q 30/0231
USPC 705/14.3

(57) ABSTRACT

The present disclosure provides systems and methods including providing a mobile application associated with a first subject matter, providing a challenge to selected users, wherein the challenge is related to a second subject matter, and rewarding the selected user upon completion of the challenge, wherein the reward is associated with the first subject matter.

### CROSS-REFERENCE TO RELATED APPLICATIONS

This application incorporates by reference and claims priority to U.S. Provisional Application No. 61/676,296 filed Jul. 26, 2012.

### BACKGROUND OF THE INVENTION

Traditional brand advertising is inefficient. The effects of advertising money spent on billboards, television advertising, yellow pages, celebrity endorsements, etc. are practically untraceable. Brands want to know that their scarce advertising money is directly creating specific desired results, whether that may be general brand awareness, brand trials, brand purchases, or otherwise. Brands only want to pay for measurable advertising performance (i.e., the completion of a specific outcome). Accordingly, brands have been abandoning print advertising and sponsorships at an increasing rate. Pay-per-click models (Google AdWords) have become popular, but are still lacking, since all pay-per-click models do is drive someone to a website and brands demand more.

There are situations in which it would be beneficial for brand managers to incentivize customers (and potential customers) to interact with the brand's goods and services. By getting customers to learn about, try, or buy a product or service, the brand may increase its exposure, increase its sales opportunities, and most importantly, increase its sales. Examples of interactions that may be beneficial for the brand include having a potential customer go to a website to get a car insurance quote, take a test drive at a local dealership, buy a product from a retailer (traditional or online), or attend a promotional event, etc.

Existing systems and methods that are adapted to incentivize customers face difficulty in validating that the customers have in fact performed the activity the brand manager wants to incentivize. Without appropriate validation, the incentive systems and methods have decreased value. In addition, many existing systems are not well adapted for measuring and analyzing the customer interaction.

In a departure from traditional advertising (e.g., television, radio, and print advertisements), increasingly brand managers are demanding pay-per-performance forms of advertising. One example of a pay-per-performance advertising model, is pay-per-click advertising such as Google AdWords. The limitation of presently employed pay-per-performance is that the performance being validated is not necessarily the performance the brand manager would ultimately like to the consumer to do. For example, in Google AdWords the brand manager pays for the consumer to click through Google's search engine and visit the brand's website. However, in many instances, visiting the brand website is an incomplete performance. The brand manager would much prefer to pay for the completion of an specific interaction with the brand including watching a video on the product, taking a survey, or making a purchase of its goods or services, not simply visiting the website, but the current tools limit the performance metrics that can be validated.

Certain categories of “brands” naturally attract a more interactive customer base. For example, brands that tend to have fans, such as athletes, teams, artists, and celebrities, tend to have more interactive customers. Accordingly, it would be beneficial for brands with less interactive customers to be able to cooperate with brands with more interactive brands to reach a target audience and it would be beneficial for the brands with more interactive customers to be able to monetize that relationship. This relationship has traditionally been exploited by endorsements of products and services. While endorsements may be beneficial, they do not create the interactive experiences with the brands that many brand managers would like to incentivize, nor is it possible to determine the effectiveness towards driving the desired consumer performance. Creating systems and methods in which these various categories of brands can work together to create proper incentives has been difficult.

Accordingly, there is a need for a system and method of interactive marketing that takes advantage of a fan base associated with a popular brand for the purpose of marketing a lesser known brand. Further, there is a need for an interactive marking system that validates the completion of an interactive marketing task using a mobile device, wherein the system effectively incentivizes users to complete the marketing tasks, as described and claimed herein.

### BRIEF SUMMARY OF THE INVENTION

The present subject matter relates generally to systems and methods for validating the completion of an interactive marketing task (challenge) using a mobile device. More specifically, the present subject matter discloses systems and method in which a first party (e.g., a famous entity) presents a challenge to their users (e.g., a fan) on their mobile application, wherein the challenge is created by a second party (e.g., a brand). Upon validation by the mobile application of a user completing the challenge related to the second party, the mobile application rewards the user, wherein the reward is associated with the first party.

The solution to the problem of conventional advertising is to drive specific consumer action with respect to a target brand by offering an incentive from a connecting brand. The solution may be implemented by capturing the consumers' attention using a brand to which they are already connected by offering a reward in exchange for the consumer taking a specific action or performance with the target brand. The solution works by appealing to consumers' desire to get “close” to the connecting entity by promising a connecting brand-related reward in exchange for doing something specifically related to the target brand.

In one illustrative example, a target company leverages a fan's connection with the connecting brand to drive the fan's performance of a specific task. For example, a fan (i.e., consumer) downloads an informational, official mobile app related to a famous athlete (i.e., connecting brand) with whom the fan is passionate about and/or emotionally connected. Subsequently, through the mobile app, the fan is exposed to a call to action (i.e., a challenge) related to a target brand. The challenge directs the fan to perform a specific action with respect to the target brand, in exchange for a reward from the athlete. For example, the athlete will grant the fan points for completing the challenge and subsequently allow the fan to redeem the points for rewards related to the athlete (e.g., memorabilia, tickets, limited access, unique experiences, etc.). The fan's interest in getting rewards from the athlete drives their action with respect to the target brand.

In the example above, an athlete may issue challenges intended to encourage customer interaction with a third-party's product. The third party benefits from leveraging the athlete's fans. The athlete benefits monetarily by being paid for the number of challenges validated by the athlete's fans. The fans benefit from being rewarded with merchandise, autographs, other exclusive rewards tailored to elicit completion and subsequent validation of the challenge.

The technical problem to solve is to prove the fan actually did what the target wanted the fan to do, thus: (1) giving the target brand the assurance that they spent their scarce advertising money wisely and, importantly, (2) justifying a measured payment by the target brand in exchange for the fans performance of the desired action. In other words, create a true pay-per-completion business model.

The solution to this problem is the use of novel validation techniques and technologies to prove that the consumer did what the target brand wanted them to do. Mobile technologies are an ideal medium for these validation techniques that may be based on the use of a mobile device's camera, GPS, microphone, internet connection, Bluetooth, application programming interface (API), near field communication (NFC), etc. The power of the mobile device is that can be leveraged to assist in the verification of the action completion in real-time and at any place the consumer is located.

The business value of the overall solution is three-fold. Target brands realize the utopia of advertising, paying advertising fees only after the consumer did what they specifically wanted them to do. Athletes, celebrities and other famous entities are able to monetize their fan base by being paid for connecting their fans to other brands. Fans get the reward/experience they desperately desire from the entity they admire most.

The inventions described herein provide practical, immediately actionable and monetizable solutions to the problems described above, as will be apparent to those skilled in the art based on the details provided in this disclosure.

The present disclosure provides a marketing challenge validation system comprising a mobile electronic device including a controller and a memory coupled to the controller, wherein the memory is configured to store program instructions executable by the controller. In response to executing the program instructions, the controller is configured to provide a mobile application accessible through a user interface provided through the mobile electronic device, wherein the mobile application is associated with a first subject matter. The controller is also configured to display a challenge on the user interface of the mobile device associated with one or more selected users, wherein the challenge is related to a second subject matter, wherein the challenge has a corresponding validation requirement. The controller is configured to receive validation data related to the second subject matter from the mobile device associated with the selected user, and provide the selected user with a reward if the validation data is within the validation requirement associated with completion of the challenge, wherein the reward is related to the first subject matter. In an embodiment, the selected users have an association with the first subject matter. The controller may be configured to select users based on age, sex, residential location, current location, occupation, interests, prior actions, and combinations thereof.

The first subject matter may be related to a first marketing brand and the second subject matter may be related to a second marketing brand, wherein the first marketing brand and second marketing brand are different.

The validation requirement may include a digital text, digital image, digital video, digital sound, API data, or combinations thereof from a mobile electronic device associated with the selected user. The validation requirement may include location information of a mobile device associated with the selected user.

In another example, the validation data may include optical code data associated the second subject matter, location information of a mobile device associated with the selected user, and a digital photograph related to the second subject matter. In another example, the validation data may include optical code data associated the second subject matter, location information of a mobile device associated with the selected user, and product information data associated with the second subject matter.

In yet another example, the validation data may include a product digital photograph related to the second subject matter, wherein the product digital photograph includes product time stamp data and product location data, and a receipt digital photograph of a receipt associated with the purchase related to the second subject matter, wherein the receipt digital photograph includes receipt time stamp data and receipt location data. The validation requirement may include API data from a social network's API, wherein the API data confirms a user action associated with the second subject matter on the user's social network page.

If the validation data is within the validation requirement, the controller may be configured to display a confirmation of validation on a user interface of a mobile electronic device associated with the selected user. If the validation data is within the validation requirement, the controller may be further configured to send the validation data to an entity associated with the first subject matter. The validation requirement may include confirmation of a selected user posting a message related to the second subject matter onto a social network.

The present disclosure also provides a validation method comprising selecting at least one selected user associated with a first subject matter, providing a challenge related to a second subject matter to the selected user, receiving validation data related to the second subject matter from the selected user, determining whether the validation data is within the validation requirement associated with completion of the challenge by the selected user, and providing the selected user with a reward related to the first subject matter, if the validation data is within the validation requirement, wherein the first subject matter and second subject matter are different.

If the validation data matches the validation requirements, the method may further include displaying confirmation of validation on a user interface of a mobile electronic device associated with the selected user

An advantage of the systems and methods provided herein is brands may induce their customers/fans/users to engage in interacting with goods and services and benefit monetarily from inducing such interaction.

Another advantage of the systems and methods provided herein is the brand interaction may be validated such that specific challenge completion can be confirmed with a high degree of certainty.

A further advantage of the systems and methods provided herein it may provide new mutually beneficial sponsorship relationships.

Another advantage of the systems and methods provided herein is that the systems and methods may be utilized to play a “matchmaker” role for connecting brands to clients (and the respective client's fan base) to whom the brand previously did not have access.

Yet another advantage of the systems and methods provided herein is that the challenge validation platform may be adapted to manage the multiple options for challenge validation and a brand manger can decide the validation scheme most appropriate for a given challenge.

Still another advantage of the systems and methods provided herein is challenges may be provided based on specific demographic or other user specific information.

Another advantage of the systems and methods provided herein is that the validation of challenges may enable the collection and analysis of user information, which may be valuable for marketing or similar purposes.

Yet another advantage of the systems and methods provided herein is that they provide a “pay-per-completion” model that is more monetarily efficient and measurable to a brand manager.

Another advantage of the systems and methods disclosed herein is that the mobile application allows a fan to earn points by posting a message from a brand or company onto the fan's social network account wherein the post does not look like a typical advertisement, but a conventional post from the fan. Because the message appears as a conventional post from a fan, the system provides brands with a more relevant and authentic exposure to the fan's own social network.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of an embodiment of the system disclosed herein.

FIG. 2 is a screen shot of a user interface showing various aspects of a mobile application disclosed herein.

FIG. 3 is a screen shot of a user interface showing various aspects of a mobile application disclosed herein.

FIG. 4 is a screen shot of a user interface showing various aspects of a mobile application disclosed herein.

FIG. 5 is a flow chart of an embodiment of the method disclosed herein.

FIG. 6 is a series of screen shots representing a validation platform as provided to a user through a mobile device.

FIG. 7 is a screen shot of a user interface showing a challenge setup screen.

FIG. 8 is a screen shot of a user interface showing a validation details setup screen.

### DETAILED DESCRIPTION OF THE INVENTION

The present disclosure provides systems and methods for validating the completion of an interactive marketing task (challenge) using a mobile device. More specifically, the present subject matter discloses systems and method in which a first party (e.g., a famous entity) presents a challenge on their mobile application, wherein the challenge is created by a second party (e.g., a brand). Upon validation by the mobile application of a user (e.g., a fan) completing the challenge related to the second party, the mobile application rewards the user, wherein the reward is associated with the first party. Various examples are provided herein.

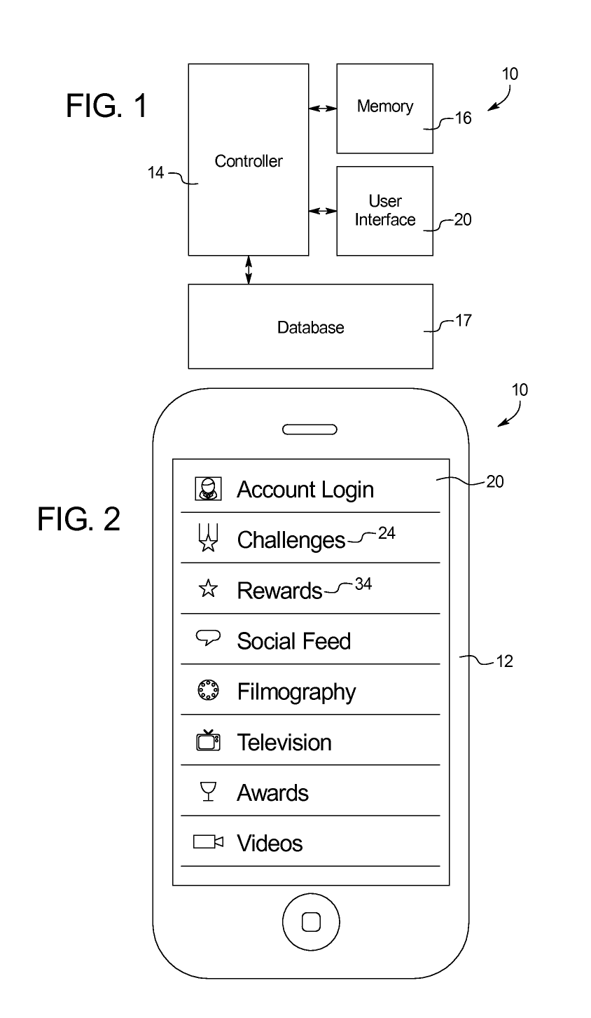

The present disclosure provides a marketing validation system 10 that includes a mobile electronic device 12 including a controller 14 and a memory 16 coupled to the controller, wherein the memory 16 is configured to store program instructions executable by the controller 14, as shown in FIG. 1. In response to executing the program instructions, the controller 14 is configured to provide a mobile application 18 accessible through a user interface 20 provided through the mobile electronic device 12, wherein the mobile application 18 is associated with a first subject matter 22.

The first subject matter 22 may be any person, place, thing, or service. For example, the first subject matter 22 may be a celebrity, sports team, product, service, or any other marketable item. The first subject matter 22 may be associated with a particular brand or business entity.

In one embodiment, a first party associated with a first subject matter 22 (e.g., an actor) manages the mobile application 18 associated with that actor, wherein the actor may communicate with his or her fans. As shown in FIG. 2, the mobile application 18 may include information about the actor's work history, appearances in film and television shows, the actor's interests, a news feed with posts from the actor, among other functions. The mobile application 18 may also include product sales and charities associated with the first subject matter 22. For example, the mobile application 18 may include the option for a user to buy event tickets, merchandise, sponsor's products, and support charities and foundations. In addition, the mobile application 18 may also have a media library, which may have direct links to stream or buy media, such as music, movies and television shows related to the first subject matter 22.

The controller 14 is further configured to display a challenge 24 on the user interface 20 of the mobile electronic device 12 associated with one or more selected users 26 (not shown). For example, a second party (e.g., a consumer product brand manager) associated with the second subject matter 28 (e.g., the consumer brand product being marketed) may wish to leverage the first party's ability to communicate to his or her fans to present a challenge to the fans to incentivize fan engagement with the second party's product. Although in the primary examples used herein, the first subject matter 22 and second subject matter 28 are associated with different entities, it is contemplated that the system 10 provided is also applicable to embodiments in which the first subject matter 22 and the second subject matter 28 are associated with the same entity. In other words, it is contemplated that in some embodiments the party issuing the challenge and the brand being promoted are the same entity.

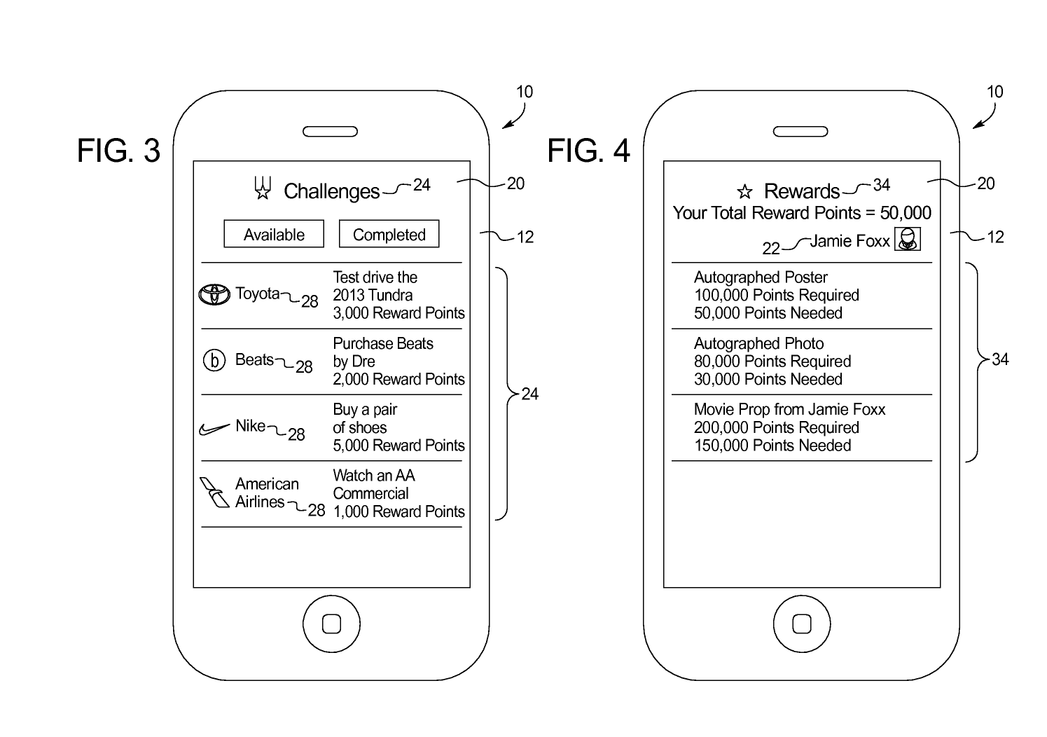

As shown in FIG. 3, an actor managing the mobile application 18 associated with the first subject matter 22 (i.e., the actor) may issue a challenge 24 to his or her fans in which the challenge 24 incentivizes the actor's fans to interact with a variety of products or services associated with the second subject matter 28. For example, as shown in FIG. 3, a mobile application 18 associated with Jamie Foxx, the first subject matter 22, may present selected users 26 with a variety of challenges related to a second subject matter 28, such as Toyota, Beats, Nike, among other.

In an example, the controller 14 is configured to select users having an association with the first subject matter 22. For example, if the first subject matter 22 is a particular famous basketball player, the controller 14 would select users having an association with that basketball player. An association could be any connection between the selected user 26 and the first subject matter 22. For example, an association may be that the selected user 26 is a fan of the basketball player, the selected user 26 has “liked” the basketball player on his or her social network page, the selected user 26 has attended five games the basketball player has played, the selected user 26 has recently purchased a shirt with the basketball player's name on the shirt, among others. In one embodiment, the selected user 26 is a subscriber of the mobile application 18.

Alternatively, or in addition to, the controller 14 may be configured to select users to whom to present the challenge 24 based on demographic information. For example, selected users 26 may be selected based on various demographic data, including age, sex, gender, location, current location, etc. and it is understood that any form of demographic data and/or conditions may be used for the selection process. In one embodiment, the selected users 26 are associated with the first subject matter 22 and meet any number of demographic parameters and/or location parameters. For example, a selected user 26 may not only be a subscriber of the mobile application 18 but also fit into a particular age group, sex, and have a particular current location, wherein the current location is determined by GPS associated with the selected user's 26 mobile electronic device 12.

Selected users 26 may alternatively, or additionally, be selected based on other preference data. Such preference data may be provided by the selected users 26 or determined from the selected user's 26 behavior. For example, a selected user 26 may opt in to receive challenges 24 for certain preferred types of goods and services, a selected user's 26 purchases may be monitored to determine preference patterns, etc. Using demographic and/or preference data to determine a subset of selected user 26 to whom to provide the challenge 24 enables a brand manager to appropriately target desired users. Demographic and preference data may be used to determine selected users 26 to include or exclude from challenge presentation. Further, the brand manager (or other entity setting up the parameters of the selected users 26 to which to present the challenge) may place limitations on the quantity, time frame, etc. for the challenges that may be presented and/or validated. For example, the brand manager may determine to implement a quantity limited pay-per-completion challenge by establishing a budget for validated challenge completions.

The challenge 24 displayed on the mobile electronic device 12 associated with one or more selected users 26 is related to a second subject matter 28, wherein the challenge 24 has a corresponding validation requirement 30. The second subject matter 28 may be any person, place or thing. For example, the second subject matter 28 may be a celebrity, sports team, product, service, or any other marketable item. The second subject matter 28 may be associated with a particular brand or business entity.

Of course it is understood that the challenge 24 may be presented to selected users 26 in any manner, including print media, online media, etc. The challenge 24 may be a single step or multi-step process. As an illustrative example, a multi-step challenge may be for a selected user 26 to buy a case of Pepsi and then buy a bag of Lay's Potato Chips from a participating Wal-Mart store.

Other examples of challenges 24 include having a selected user 26 check-in at a promotional event associated with the second subject matter 28. For example, a selected user 26 that subscribes to a mobile application 18 associated with the first subject matter 22 (e.g., particular singer) may be issued a challenge 24 associated with a second subject matter 28 (e.g., brand of sunglasses), wherein the challenge 24 includes the selected user 26 attending a promotional event related to the second subject matter 28 (i.e., the brand of sunglasses). Additional examples of challenges include having a selected user 26 take a test drive at a local dealership, interact with a product at a store, purchase a product at a specific store, sign up for an email list relating to the second subject matter 28, obtain an auto insurance quote online, watch a video at a particular website associated with the second subject matter 28, “like” a Facebook page associated with the second subject matter 28, share a message using a social network, or watch a TV show or commercial in real time, among others.

The controller 14 is configured to receive validation data 32 related to the second subject matter 28 from the mobile electronic device 12 associated with the selected user 26. For example, based on the challenge validation rules provided by the mobile application 18, the selected user 26 may be prompted to validate the completion of the challenge 24. In some embodiments, the selected user 26 may be given multiple options for validation. In other examples, there may be only a single supported validation method.

There are many examples of validation requirements 30 and corresponding validation data 32 that may be supported by the systems 10 and methods 11 disclosed herein. Several examples are described herein as illustrative of the challenge validation. However, it is contemplated that those skilled in the art will understand a wide range of potential challenge validation methods based on the examples provided herein. For example, the validation requirement 30 may include digital text, digital image, digital video, digital sound, or combinations thereof from a mobile electronic device 12 associated with the selected user 26.

In an example, a challenge 24 may have a validation requirement 30 of sending and/or receiving data from a third party application through the third party's API. In other words, the validation requirement 30 may be sending and/or receiving API data. For example, a particular challenge 24 may include a user “liking” on a Facebook page related to a particular product associated with a second subject matter 28. After the user selects “like,” the mobile application 18 may automatically send and receive the API data from Facebook to validate the user indeed “liked” the second subject matter 28 Facebook page and award the user points. Similarly, a particular challenge 24 may be for a user to post a photo of a particular product or message from a particular company associated with a second subject matter 28 on his or her social network page, wherein upon posting the mobile application 18 automatically receives the API data from the social network's API and awards the user points associated with the first subject matter 22. Alternatively, instead of a user posting a message related to the second subject matter 28 on his or her social network site, the mobile application 18 may automatically send the message to the social network's API, and post the message on behalf of the user, upon authorization of the user. The message displayed on the user's social network's site appears as an authentic message from the user, rather than an advertisement from a company related to the second subject matter 28.

In yet another example, a challenge 24 may have a validation requirement 30 of receiving authorization from a user that allows the mobile application 18 to send the user's contact information to the company associated with the first subject matter 22 or second subject matter 28. Upon receiving confirmation from the API, the mobile application 18 rewards the user points associated with the first subject matter 22.

In another example, a challenge 24 may have a validation requirement 30 including optical code data associated with the second subject matter 28. For example, the optical code data may be a photograph taken by the selected user 26 that is optically recognized to match an optical code using a mobile electronic device 12. For example, an optical code may be any object, shape, bar code, QR code, or purchase receipt. In another example, the challenge 24 may have a validation requirement 30 including a manual entry of a code (e.g., a one-time use code) into a website or mobile application. In another example, a mobile electronic device 12 may detect a beacon using NFC (near field communication), Bluetooth, or another short-range communication protocol. The selected user's 26 location may be used as part of the validation requirement 30 based on the GPS location of the selected user's 26 mobile electronic device 12. In still another example, a mobile electronic device 12 may be used to capture a unique sound, for example, a sound provided at a location where a challenge may be completed and validated. Greater complexity of validation requirements 30 may lead to more certainty in the validation process. For example, a validation requirement 30 may require a combination of NFC, GPS, and time/date validation.

In a specific example of a more complex validation requirement 30, a selected user 26 may validate being in a Wal-Mart store by checking in via GPS, then entering code data, for example, scanning an optical code (e.g., QR code or UPC bar code) on the outside of the packaging of a case of Pepsi, then type in a unique code provided on the inside of a bag of Lay's Potato Chips, and finally take a picture of the receipt showing the purchase of the case of Pepsi and the bag of Lay's Potato Chips. Another example multi-step challenge 24 validation requirement 30 includes taking a picture of a product, a receipt, and a State issued ID with camera phone, with the pictures and other information from the phone (e.g., a user ID, challenge ID, GPS coordinates, time stamp, etc.) provided to a manual screener for validation (e.g., a remote call/service center). In another example, the validation requirement 30 may include scanning (or otherwise entering) a code coordinated with GPS coordinates and time stamp validating that the user was at a given location within a given time frame open (e.g., while the business is open 9 AM-5 PM Monday through Friday).

In one example, the validation requirement 30 may include a product digital photograph related to the second subject matter 28, wherein the product digital photograph may include product time stamp data and product location data and a receipt digital photograph of a receipt associated with the purchase related to the second subject matter 28. The receipt digital photograph may include receipt time stamp data and receipt location data. The validation requirement 30 may include the product time stamp data to be within ten minutes of the receipt time stamp data, and the product location data to be within one mile of the receipt location data.

The controller 14 is further configured to provide the selected user 26 with a reward 34 if the validation data 32 is within the validation requirement 30 associated with completion of the challenge 24, wherein the reward 34 is related to the first subject matter 22. In addition, it is contemplated that challenges 24 may be validated manually, automatically, or a combination of both. After the challenge 24 is validated, the selected user 26 may be rewarded. Various rewards 34 are contemplated, including reward points, awards, etc.

As shown in FIG. 3, the challenges associated with a second subject matter 28 (such as, Toyota, Nike, American Airlines) may have a corresponding number of reward points that a selected user 26 would earn upon completion of the challenge 24, wherein the reward points are applicable to the first subject matter 22 (e.g., Jamie Foxx's autograph). For example, FIG. 4 shows an example of possible rewards 34 displayed on a user interface 20, wherein the rewards 34 include an autographed poster of Jamie Foxx when the selected user 26 has obtained 100,000 points. As shown in FIG. 4, the selected user 26 has already earned 50,000 points from completing challenges but still needs 50,000 points to obtain the autographed poster reward 34.

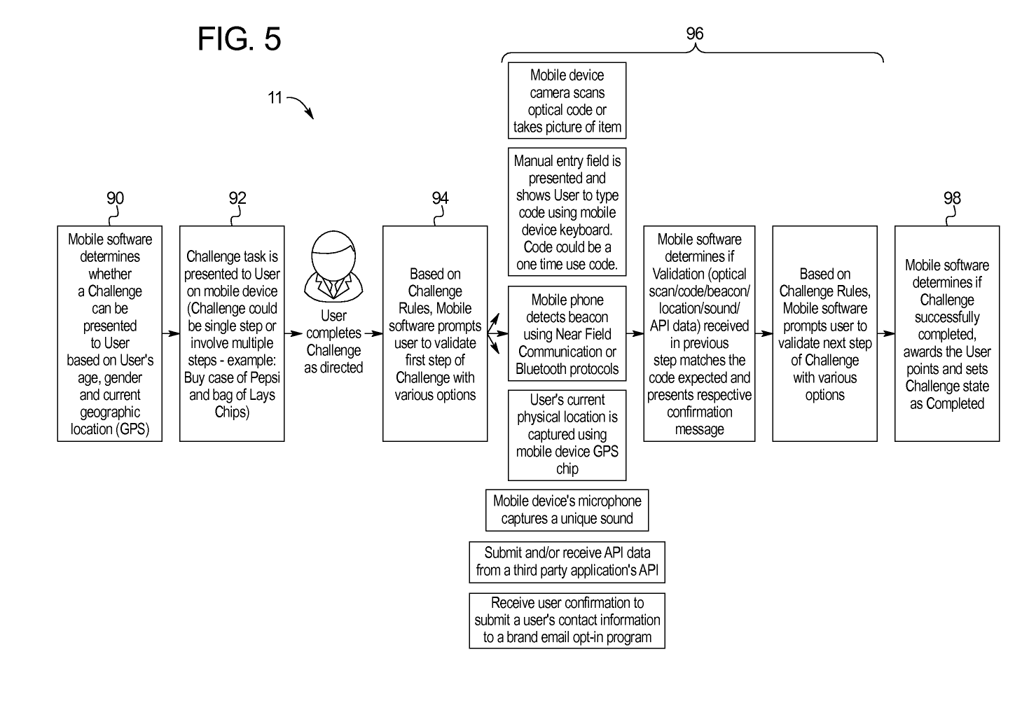

FIG. 5 illustrates an example of a method 11 for validating the completion of a challenge 24, such as an interactive marketing task, using a mobile electronic device 12. As shown in FIG. 5, the method 11 presents a series of steps to a user to validate the completion of a challenge 24. In one embodiment, the method 11 includes a first step 90 of selecting at least one user associated with a first subject matter 22 and a second step 92 of providing a challenge 24 related to a second subject matter 28 to the selected user 26. The method 11 further includes a third step 94 of receiving validation data 32 related to the second subject matter 28 from the selected user 26 and a fourth step 96 determining whether the validation data 32 is within the validation requirement 30 associated with completion of the challenge 24 by the selected user 26. The method 11 also includes a fifth step 98 of providing the selected user 26 with a reward 34 related to the first subject matter 22, if the validation data 32 is within the validation requirement 30.

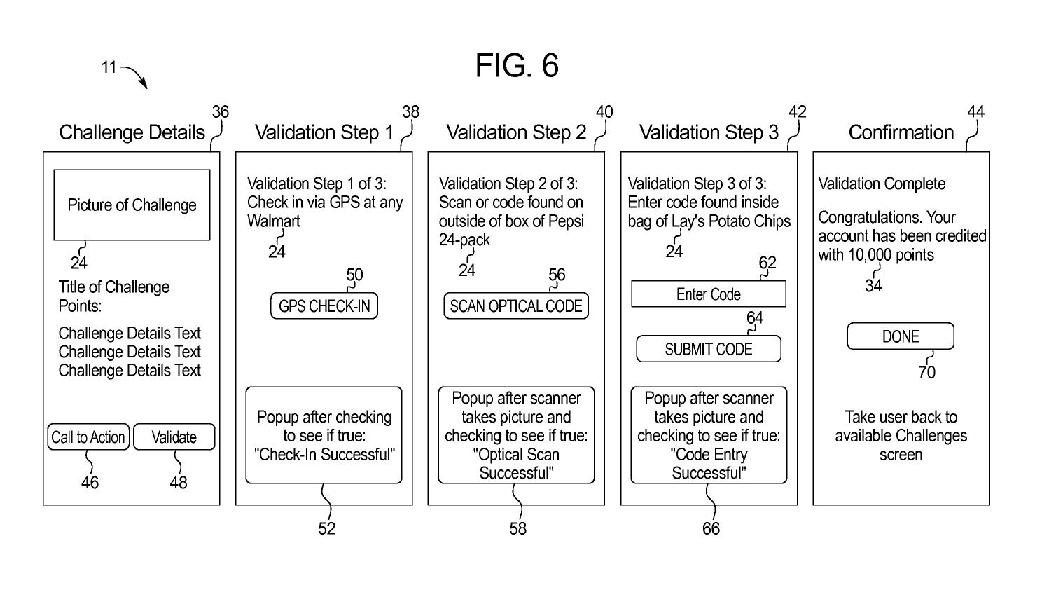

In the example shown in FIG. 6, the method 11 provides: a challenge details interface 36; a first validation step interface 38; a second validation step interface 40; a third validation step interface 42; and a confirmation interface 44. The example provided in FIG. 6 is merely one example of an embodiment of the system 10 and method 11 provided to a selected user 26 through a mobile electronic device 12. It is contemplated that there are many variations in the manner in which the system 10 and method 11 may be expressed.

In the example used in FIG. 6, a selected user 26 is issued a challenge 24 to check-in via GPS at a Wal-Mart. Then, the selected user 26 must scan a QR code located on the outside of a 24-pack Pepsi box. Finally, the third step of the validation challenge 24 is to enter a code found inside a bag of Lay's Potato Chips. The reward 34 for validating this challenge 24 is a reward 34 of a credit of 10,000 points.

As shown in FIG. 6, the challenge details interface 30 includes a picture of the challenge 24 as well as text describing the challenge details. A call to action button 46 may be provided through which a selected user 26 may get additional details concerning the steps required to complete the issued challenge 24 and a validate button 46 through which a selected user 26 may initiate the validation process.

Once a selected user 26 initiates the validation process via the validate button 48, the first validation step interface 38 is provided via the mobile electronic device 12. As shown, the first validation step interface 38 includes a description of the validation requirement 30, a GPS check-in button 50 is provided for the validation of the first step. Once the validation of the GPS check-in is complete, the first validation step interface 38 may provide a successful validation notification 52.

After the successful validation of the first validation step, the second validation step interface 40 is provided via the mobile electronic device 12. As shown, the second validation step interface 40 includes a description of the validation requirement 30 and a scan optical code button 56 for validating the second step. Once the validation of the optical scan is complete, the second validation step interface 40 provides a successful validation notification 58.

After the successful validation of the second validation step, the third validation step interface 42 is provided via the mobile electronic device 12. As shown, the third validation step interface 42 includes a description of the validation requirement 30, a code entry form 62 and a code submission button 64 for validating the third step. Once the validation of the code submission is complete, the third validation step interface 42 provides a successful validation notification 66.

After the successful validation of the third validation step, the confirmation interface 44 is provided via the mobile electronic device 12. As shown, the confirmation interface 38 includes a confirmation of the reward 32 credited to the selected user 26 and an end button 70 that completes the validation process.

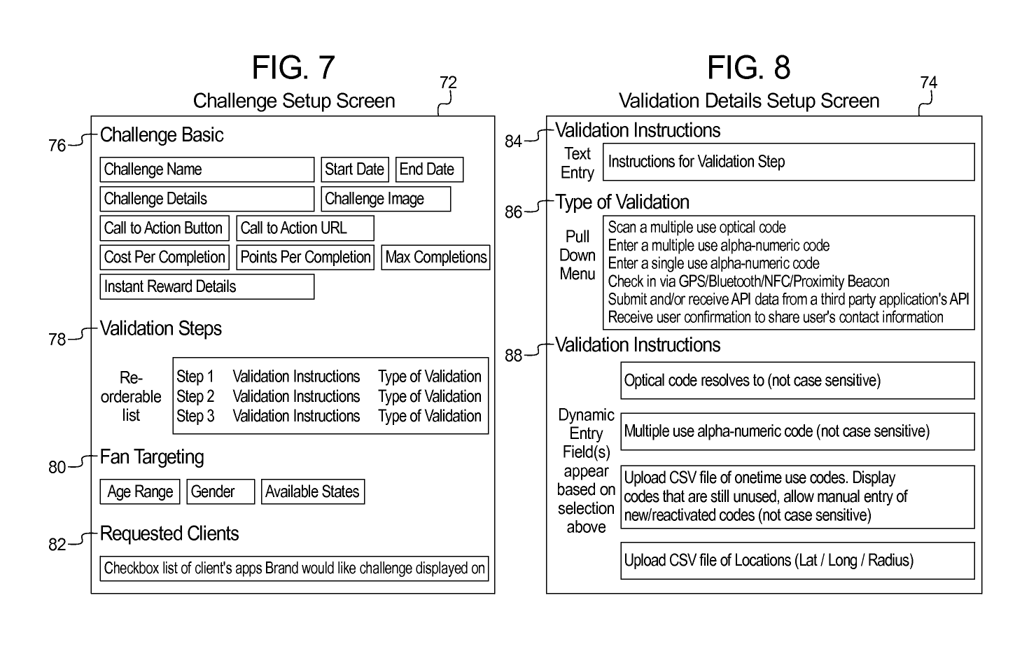

Turning now to FIG. 7, an example of a challenge setup screen 72 is shown. In FIG. 7, an example of a validation details setup screen 74 is provided. The challenge setup screen 72 and validation details setup screen 74 may be provided, for example, as part of a content management system through which challenges and validations may be managed.

As shown in FIG. 7, the challenge setup screen 72 may include a challenge basics section 76 in which a challenge manager may provide relevant challenge details. For example, the challenge name, start date, end date, challenge details, challenge image, call to action button information, call to action URL, cost per completion, points per completion, maximum completions, instant reward details, etc. The challenge setup screen 72 may include a validation steps section 78, through which the challenge manager may provide any number of validation steps, validation instructions, and identification of the type of validation. In the fan targeting section 80, the challenge manager may define challenge parameters such as: age range, gender, and location, for challenge validation eligible users. A requested clients section 82 is further provided through which a challenge manager (e.g., Toyota) may request a list of client apps (e.g., Jamie Foxx) through which the challenge manager would like to issue their challenge to be displayed on. Next, the managers of the selected client apps (related to the first subject matter 22) must accept to display the challenge related to the second subject matter 28 (e.g., Toyota). In other words, if Toyota selects Jamie Foxx's app to display Toyota's challenge, Jamie Foxx must also accept Toyota's challenge to display on his app.

In a further example, once a brand manager creates a challenge 24, the brand manager selects which client mobile applications 18 they would like the challenge 24 to be displayed. The system 10 sends an email to the client application manager to decide if the mobile application 18 should display the challenge 24 from the brand manager. The email may contain a button that allows the client application manager to accept or decline displaying the challenge 24 on their mobile application 18. Only if the client mobile application manager accepts the challenge 24, will the challenge 24 be displayed on the client's mobile application 18. This particular acceptance mechanism prevents client's from displaying challenges 24 from brands which may have a conflict of interest. Of course, FIG. 7 is merely one example of a challenge setup screen 72 and various embodiments of challenge setup screens 72 may be employed, as will be understood by those skilled in the art based on the examples provided herein.

In another example,

As shown in FIG. 8, the validation step details setup screen 74 may include a validation instructions section 84 in which a challenge manager may provide instructions for the validation of the challenge, for example though a text entry form. As further shown, the validation details setup screen 74 may further include a type of validation section 86 through which a challenge manager may select various validation types to be used in the validation process. The validation instructions section 84 may change according to the selected type of validation. The validation types may be selected, for example, using a pull-down menu selector. Finally, the validation details setup screen 74 may include a validation check section 88 through which a challenge manager may provide the information required to validate the specific validation types selected. The validation check section 88 may be populated with dynamic entry fields based on the selections made in the type of validation section 86. The validation instructions may further include any suitable instructions based on the type of validation selected. For example, the validation instructions may include API addresses and data fields to send or receive from the API, a sound file to upload and match, a picture to analyze and match, or a time requirement for validation to occur, among others. FIG. 8 is merely one example of a validation details setup screen 74 and various embodiments of validation details setup screens 74 may be employed, as will be understood by those skilled in the art based on the examples provided herein.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A marketing challenge validation system comprising:
a mobile electronic device including a controller;
a memory coupled to the controller, wherein the memory is configured to store program instructions executable by the controller;
wherein, in response to executing the program instructions, the controller is configured to:
provide a mobile application accessible through a user interface provided through the mobile electronic device, wherein the mobile application is associated with a first subject matter;
display a challenge on the user interface of the mobile device associated with one or more selected users, wherein the challenge is related to a second subject matter, wherein the challenge has a corresponding validation requirement;
receive validation data related to the second subject matter from the mobile device associated with the selected user; and
provide the selected user with a reward if the validation data is within the validation requirement associated with completion of the challenge, wherein the reward is related to the first subject matter.

2. The system of claim 1 wherein the selected users have an association with the first subject matter.

3. The system of claim 1 wherein the controller is configured to select users based on age, sex, residential location, current location, occupation, and combinations thereof.

4. The system of claim 1 wherein the first subject matter is related to a first marketing brand and the second subject matter is related to a second marketing brand, wherein the first marketing brand and second marketing brand are different.

5. The system of claim 1 wherein the validation requirement includes a digital text, digital image, digital video, digital sound, API data, or combinations thereof from a mobile electronic device associated with the selected user.

6. The system of claim 1 wherein the validation requirement includes location information of a mobile device associated with the selected user.

7. The system of claim 1 wherein the validation requirement includes:
optical code data associated the second subject matter,
location information of a mobile device associated with the selected user, and
a digital photograph related to the second subject matter.

8. The system of claim 1 wherein the validation requirement includes:
optical code data associated with the second subject matter,
location information of a mobile device associated with the selected user, and
product information data associated with the second subject matter.

9. The system of claim 1 wherein the validation data includes:
a product digital photograph related to the second subject matter, wherein the product digital photograph includes product time stamp data and product location data; and
a receipt digital photograph of a receipt associated with the purchase related to the second subject matter, wherein the receipt digital photograph includes receipt time stamp data and receipt location data.

10. The system of claim 1 wherein the validation requirement includes receiving API data from a social network's API, wherein the API data confirms a user action associated with the second subject matter on the user's social network page.

11. The system of claim 1 wherein, if the validation data is within the validation requirement, the controller is configured to display a confirmation of validation on a user interface of a mobile electronic device associated with the selected user.

12. The system of claim 1 wherein, if the validation data is within the validation requirement, the controller is further configured to send the validation data to an entity associated with the first subject matter.

13. The system of claim 1 wherein the validation requirement includes confirmation of a selected user posting a message related to the second subject matter onto a social network.

14. A challenge validation method comprising:
selecting at least one selected user associated with a first subject matter;
providing a challenge related to a second subject matter to the selected user;
receiving validation data related to the second subject matter from the selected user;
determining whether the validation data is within the validation requirement associated with completion of the challenge by the selected user; and
providing the selected user with a reward related to the first subject matter, if the validation data is within the validation requirement,
wherein the first subject matter and second subject matter are different.

15. The method of claim 14 wherein the first subject matter is related to a first company and the second subject matter is related to a second company, wherein the first company and second company are different.

16. The method of claim 14 wherein the validation data includes a digital text, image, video, sound, API data, or combinations thereof from a mobile electronic device associated with the selected user.

17. The method of claim 14 wherein the validation data includes receiving location information of a mobile device associated with the selected user.

18. The method of claim 14 wherein the validation data includes:
optical code data associated with the second subject matter,
location information of a mobile device associated with the selected user, and
a digital photograph of a receipt indicating purchase of the second subject matter.

19. The method of claim 14 wherein the validation data includes:
optical code data associated with the second subject matter,
location information of a mobile device associated with the selected user, and
product information data associated with the second subject matter.

20. The method of claim 14 wherein, if the validation data matches the validation requirements, the method further includes displaying confirmation of validation on a user interface of a mobile electronic device associated with the selected user.
